(19) United States
(12) Patent Application Publication
(10) Pub. No.: US 2002/0097854 A1
(43) Pub. Date: Jul. 25, 2002

(54) ANI-BASED DIALING IN TELEPHONE NETWORKS

(76) Inventor: THOMAS MICHAEL BAUER, BELLE MEAD, NJ (US)

Correspondence Address: William Ryan, Law Offices of William Ryan, P. O. Box 574, Springfield, NJ, 07081, US

(21) Appl. No.: 09/274,060

(22) Filed: Mar. 22, 1999

(51) Int. Cl. H04M 15/00; H04M 17/00

(52) U.S. Cl. 379/144.01; 379/114.2

(57) ABSTRACT

The number of digits required to place a pre-paid card (or other special service) telephone call is reduced by using information derived from prior calls from a particular originating station and stored at a special service call platform. Originating station information, typically ANI and account number and PIN information associated with a particular pre-paid card is stored at the platform. Subsequent calls to the platform from the same originating station use this stored information to identify the account; the account number and PIN are, in accordance with an illustrative embodiment, taken to be the same as for the immediately preceding call with the same ANI information. An authorization expiration is advantageously associated with ANI information and selected originating locations, e.g., coin stations, hotels and the like are denied simplified authorization to minimize the potential for unauthorized use. Account information may also include default called party information to further reduce the number of dialed digits required.

### FIELD OF THE INVENTION

The present invention relates generally to the field of telecommunications. More particularly, the present invention relates, in one aspect, to use of automatic number indicator (ANI) data to simplify dialing of telephone numbers. Still more particularly, aspects of the present invention relate to use of ANI-based calling in Internet telephony, pre-paid calling, calling card, and other telecommunications services.

### BACKGROUND OF THE INVENTION

Increasingly, telephone networks provide a variety of new and enhanced services using one or more service “platforms” adapted to the special requirements of the respective services. Thus, for example, calling card and toll-free (e.g., 8xx) calls are processed using platforms such as “network control points,” “service control points (SCPs),” or similar database-centered network nodes. Internet telephone and pre-paid card calling services also typically involve the use of respective associated platforms. In some cases, platforms for more than one of these classes of service can be combined into a single physical network node, or the platforms can be adjuncts to-or part of-network switches or other network nodes.

Placing calls through telecommunications networks using these platforms typically requires that the calling party provide certain identification and authentication information before the call can be completed. For example, a caller using a pre-paid calling service illustratively purchases a pre-paid calling card providing an initial allotment of calling services, which card has associated with it an account number and personal identification number (PIN). (The account number and PIN are often combined into a single numerical string.) Upon dialing a number (typically a local or toll-free number) to connect to the pre-paid card calling platform, the user is prompted for the account number and PIN. If this information is correctly entered and is found by the platform to correspond to an account having an appropriate balance of unused services, the caller is then prompted to enter the called number. The call is then completed in accordance with well-known network processing appropriate to the class of call, subject, however, to termination by the platform if the call exhausts the available balance of unused services prior to normal call completion.

If a caller wishes to place a second or subsequent pre-paid card call, the entire process of caller identification, authentication and called party identification must be repeated, even if the calling and called parties are the same. Dialing or keying of the many digits to effectuate this process is inherently susceptible of human error. Such errors tend to cause user frustration and to impose a burden on network facilities without producing a useful result.

Similar shortcomings arise in other services, such as Internet telephony applications and calling card (or credit card) calling. In the case of calling card applications, some of the dialing requirements can be reduced in some systems by permitting a caller to depress a single key, e.g., the “#” key commonly found on telephone keypads, to receive a new dial tone after a first calling card call is complete. Minimum duration requirements are sometimes placed on the period for which such a key must be depressed, which can lead to caller confusion and possible failure to receive the follow-on dial tone.

### SUMMARY OF THE INVENTION

Limitations of the prior art are overcome and a technical advance is made in accordance with the present invention described in illustrative embodiments herein.

In one illustrative embodiment, the number of digits required to place a pre-paid call using a particular pre-paid card is reduced by using information stored at the pre-paid call platform, which information is derived from prior calls using the particular card. More specifically, once a call is placed from a given originating station using the account number and PIN information associated with a particular card, the platform stores that information along with the automatic number identification (ANI) information corresponding to the originating location received at the pre-paid card platform. Then, for subsequent calls to the platform from the same originating station, the ANI information is used to identify the account; the account number and PIN are taken to be the same as for the immediately preceding call from the station identified by the received ANI information. If the account has a sufficient remaining balance, the call subsequent to the first (fully authenticated) call is also completed.

If the purchaser of a particular pre-paid card seeks to place a call from a second or subsequent originating station, then the account number and PIN for that card will again be entered. For security purposes, a time limit may advantageously be placed on one or all account information to minimize the potential for unauthorized use. In accordance with another aspect of the present invention, selected originating locations, e.g., coin stations, are advantageously prohibited from being included in ANI-based account information stored at a network database in accordance with embodiments of the present invention.

In accordance with yet another aspect of the present invention, account information stored at a network database is augmented with a default called location. Thus, when operative, this feature will cause a default called number to be accessed from the stored account information stored at the pre-paid card platform. Since a user of a pre-paid card may place calls from a plurality of different originating stations (each of which is authenticated upon first use), the same default called number can be invoked from some or all calling stations identified in the stored account information, or a different default called number can be associated with each calling station.

It proves advantageous in accordance with other aspects of the present invention to provide for the optional entry of new account information for a particular originating station, rather than completing a call based on the account information last used in attempting a call from that particular originating station. Likewise, though a default called location may have been previously authorized, the present invention provides for the entry of new called party information to override such default information.

### BRIEF DESCRIPTION OF THE DRAWING

The above-summarized description of illustrative embodiments of the present invention will be more fully understood upon a consideration of the following detailed description and the attached drawing, wherein:

FIG. 1 is an overall view of a typical telecommunications system embodiment of the present invention, including a special service platform illustratively used in completing pre-paid card calls.

FIG. 2 illustrates the passage of an initial address message passing through an illustrative SS7 network, with selected signaling information expanded for more complete review.

FIG. 3 is a block diagram showing selected elements of an illustrative special service platform of the type shown in FIG. 1.

FIG. 4 is a flow chart showing processing steps in the network of FIG. 1 in accordance with an illustrative embodiment of the present invention.

### DETAILED DESCRIPTION

Illustrative System Overview

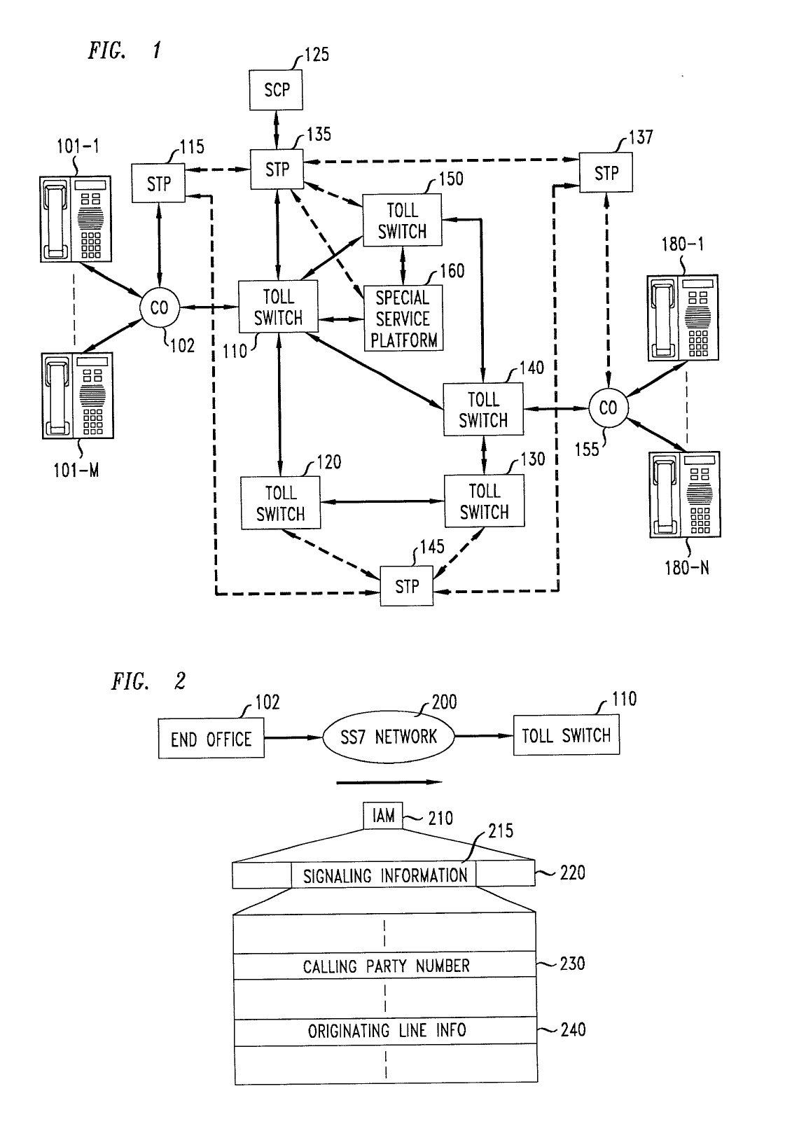

FIG. 1 shows an application of the present invention in an illustrative telecommunications network. There, a plurality of telephone stations 101-i and 180-j is shown connected to each of illustrative central office (CO) switches 102 and 155, respectively. These central office switches (typically local exchange carrier switches) are shown connected via voice paths to a network including representative toll switches 110, 120, 130, 140, 150. These toll switches may be local exchange carrier (LEC), inter-exchange carrier (IXC) or other switches interconnected in a network. Also connected to central office and other switches in FIG. 1 are representative signal transfer points (STPs) 115, 135, 137 and 145. Interconnection of these STPs is shown in FIG. 1 by broken lines reflecting signaling paths in a manner representative of an illustrative signaling system 7 (SS7) signaling network. SCP 125 is a representative service control point (SCP) for providing routing and other stored information in support of intelligent network services, as is well known in the telecommunications arts. Collectively, the switches, STPs and SCP for a representative portion of the overall public switched network (PSTN) are well known in the telecommunications arts. Alternatively, the network of FIG. 1 may represent a private switched network or a combination of a private network and the PSTN.

Further descriptions of networks of the type shown generally in FIG. 1 may be found in the literature, including, e.g., Intelligent Networks, by Jan Thorner, Artech House, Norwood, Mass., 1994, and Signaling System 7, by T. Russell, McGraw-Hill, N.Y., 1995. One illustrative application of an SS7 network of the general type shown in FIG. 1 is described in U.S. Pat. No. 5,367,566, entitled “Common Channel Signaling Message Intercept System,” issued Nov. 22, 1994 to Moe, et al, which patent is hereby incorporated by reference in the present description as if set forth in its entirety herein.

Also shown in FIG. 1 is a special services platform 160. In the following description, special services platform 160 will illustratively assume the form of a pre-paid card call processing platform. Those skilled in the art will recognize, however, that the operation of the network of FIG. 1, and the special services platform 160 (hereinafter platform 160) in particular, in accordance with illustrative embodiments of the present invention will find application in other contexts, such as Internet calling, calling card and other special services. Platform 160 is shown in FIG. 1 as interconnected with illustrative toll switches 110 and 150, as well as STP 135. As will be described below, platform 160 may perform some of the same functions as other SS7 nodes, as well as some functions specially related to its special service functions.

In particular, SS7 messages sent and received over the illustrative SS7 network of nodes (including switches, STPs, SCPs and other SS7-enabled nodes) shown in FIG. 1 convey a variety of signaling and control information, as is known in the art. For example, originating switches, such as CO 102 in FIG. 1, are adapted to formulate and send so-called initial address messages (IAMs) to other nodes in an SS7 network that are involved in call setup and control. While an IAM may include a variety of information not immediately relevant to an understanding of the present invention, it also typically includes calling party information and originating line information, some or all of which may be used in embodiments of the present invention.

FIG. 2 shows the manner in which an illustrative IAM message passes from an end office (such as CO 102 in FIG. 1) to another network node (illustratively toll switch 110 in FIG. 1) through the illustrative SS7 network of FIG. 1. In FIG. 2, oval 200 represents the SS7 network. As it passes through SS7 network 200 the IAM (represented as a whole by 210 in FIG. 2) may be examined for a variety of useful information. Of particular interest in the present example is information included in the signaling information portion of IAM, which portion 215 is shown in the expanded view of IAM represented by 220 in FIG. 2. The signaling information portion 215 of IAM 210 (and 220) is shown further expanded into a number of fields, including calling party number field 230 and originating line information (OLI) field 240 in FIG. 2. Information in fields 230 and 240 in FIG. 2 is often referred to as Automatic Number Identification (ANI) and is traditionally used for billing identification and other purposes. In appropriate cases other particular information may be included in ANI portions of SS7 messages, but such information is not essential to practice of the present invention.

Parsing of IAM information in the manner shown in FIG. 2 may be accomplished in SS7 networks using a variety of means, as is well known in the telecommunications arts. The incorporated Moe, et al patent shows one particular technique for intercepting IAM messages, but any of a variety of techniques may be used to discern some or all of the ANI information in an IAM received at an SS7 node.

While the use of the SS7 messages to pass information through a network is sufficient in many network arrangements, there are other network arrangements which supplement the SS7 mechanism in transporting call related information to a destination point, such as the special service platform. In many commercial applications, an ISDN PRI signaling mechanism is often used to deliver calls from a network switch 110 to a service platform 160. The ISDN PRI interface also supports the delivery of call related information such as ANI, called number, dialed number, OLI, etc.

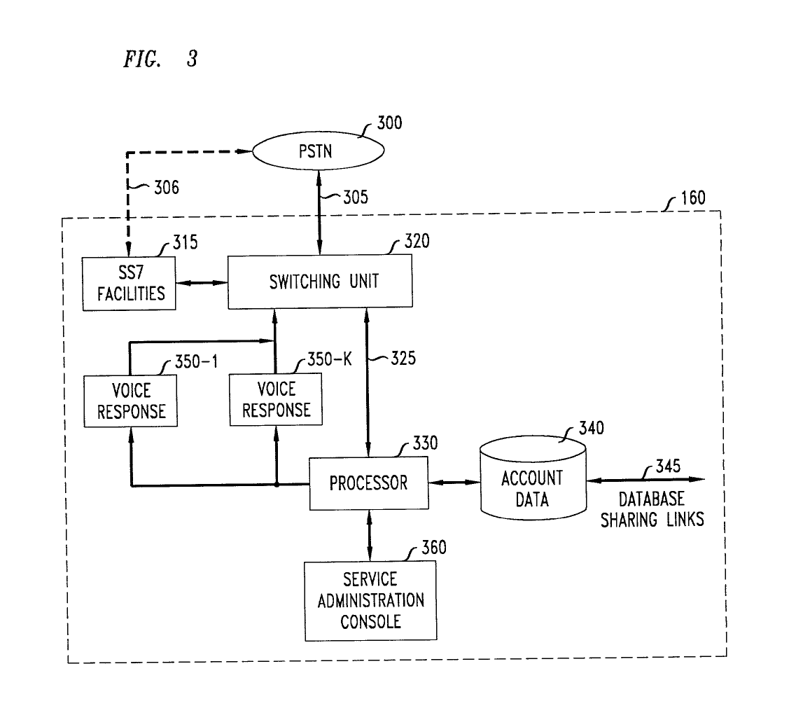

Shown in FIG. 3 is a representative special service platform 160 of the general type shown in the network of FIG. 1. Also shown there is an oval 300 representative of the portion of the network (illustratively, the PSTN) to which the special services node 160 is connected. The link 305 shown connecting platform 160 and network represents the talking paths for exchange of voice (or other signals), while link 306 represents signaling and control information paths, such as SS7 message links. Voice (or other content-such as user-supplied data) signals received over paths in the network of FIG. 3 that are directed to platform 160 are received by switching unit 320 for further processing at platform 160. Likewise, control and signaling messages received from network 300 at platform 160 in FIG. 3 are processed in illustrative SS7 processing facilities 315 to extract message content. If control information is contained in signals received over voice (or other content) paths such control information (e.g., DTMF tones originated by a user at a station such as 101-i in FIG. 1) signals are passed to node processor 330 shown in FIG. 3. These signals may be detected by equipment in the switching unit 320 or by voice response units 350-i engaged by the switching unit to detect such inputs, as described below.

Also shown in platform 160 in FIG. 3 is a plurality of voice response units (VRUs) 350-i, i=1, 2 . . . k appropriate to the purpose of the illustrative services platform. Thus, upon receipt of signaling or other control information requiring voice announcements or messages to be sent to a calling (or other) station, a VRU is engaged by processor 330 to supply the needed voice response to or input signal detection from the desired location. A typical voice message, e.g., one prompting a calling party to supply account or other information, is then delivered over a voice path connecting the platform 160 and the calling station.

Also shown at platform 160 in FIG. 3 is a database system 340 storing, inter alia, illustrative account data such as for pre-paid calling cards from a communications carrier or other provider of cards. In appropriate cases, database 340 may communicate with other network or sponsor databases over signaling paths selected by processor 330, or by other means (shown by database sharing link 345), to augment account information not available at platform 160. Processor 330 is of conventional design and operates on account information stored in database 340 (and other shared databases, as appropriate) and on data and control information received by platform 160 from network 300 or from local or remote system administrators. Local system administrator input, e.g., relating to newly issued pre-paid calling cards, is illustrated by service console 360.

Design and operation of the several individual elements of illustrative pre-paid card calling platform 160 are well known in the telecommunications arts. For example, a pre-paid card platform is described in U.S. Pat. No. 5,353,335, issued Oct. 4, 1994 to D'Urso, et al, which patent is hereby incorporated by reference in the present disclosure as if set forth in its entirety herein. In particular, the D'Urso et al patent describes a pre-paid service platform for interacting with users in several languages. Illustrative billing aspects of operation of a network platform used in completing certain special service calls, including pre-paid telephone card calls and calling card calls, is described in U.S. Pat. No. 5,844,972, issued Dec. 1, 1998 to Jagadish, et al and assigned to the assignee of the present application. The last cited U.S. Pat. No. 5,844,972 is hereby incorporated by reference in the present application as if set forth herein in its entirety herein. Use of additional or adjunct databases in processing of pre-paid card telephone calls is well-known in the art.

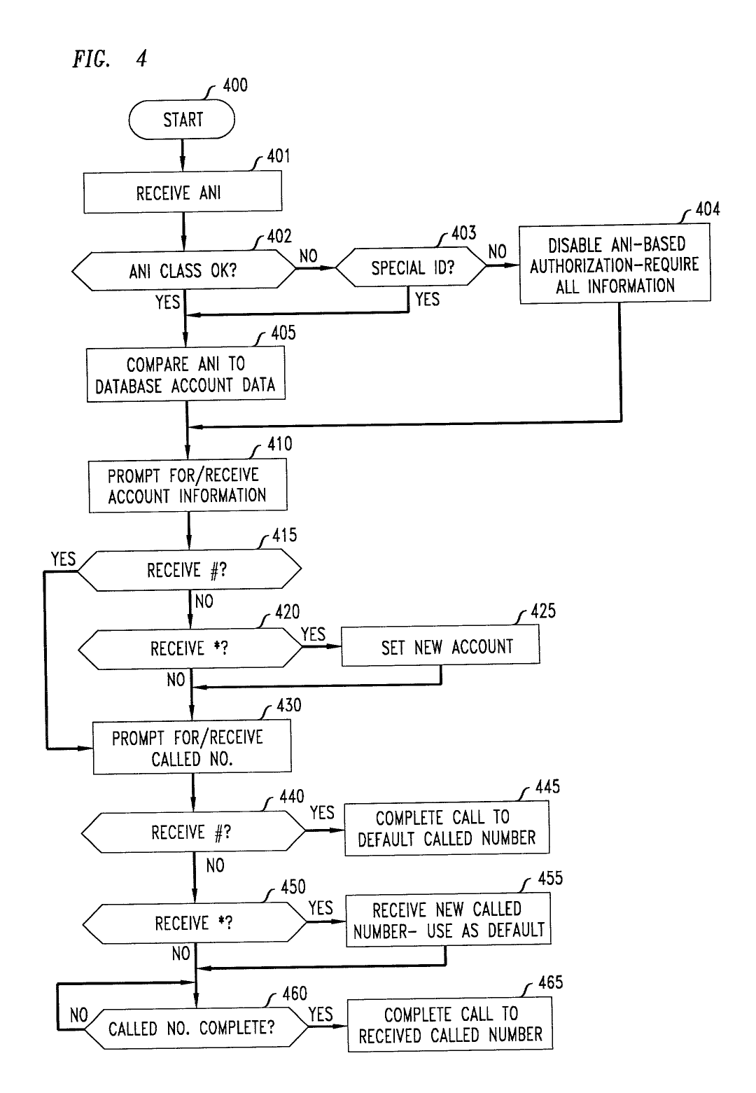

FIG. 4 is a flow chart showing typical steps performed in a network of the type shown in FIG. 1 in processing special service calls in accordance with an illustrative embodiment of the present invention. For purposes of definiteness, the steps are those associated with an inventive embodiment for processing pre-paid card calls.

Initially, it should be noted that pre-paid card calls are, in some cases, advantageously treated differently depending on whether the originating station is a coin telephone, a hotel or motel telephone or other special categories of telephone stations where fraudulent use of telephone facilities are less subject to individual accountability. Accordingly, it proves useful to employ ANI information (including originating line information) received at a special service platform in an IAM message to determine whether the calling station is in a category or class of originating station that should be treated in a more restrictive manner. Thus, in the flowchart of FIG. 4, after starting at element 400 and receiving ANI information in an IAM (or otherwise) at block 402 for a present call, the “class” of ANI information is tested at decision block 402. For most calling stations, such as home or office stations, the test will yield a positive or YES result, but for selected categories (usually determined by the service operator), e.g., coin stations, the test will yield a negative or NO result. The case of processing following a YES result at block 402 will be described first.

At block 405 the received ANI information is compared with account data stored in a database, such as database 340 in FIG. 3. If the illustrative pre-paid card call platform 160 of FIGS. 1 and 3 has previously processed a pre-paid card call from the station corresponding to the received ANI, then certain database entries will illustratively have been made. Specifically, the ANI itself will be recorded, as well as account number and PIN information (the latter pair illustratively appearing as a single string of digits). In addition, it proves convenient in some circumstances to allow a user to connect to a predetermined “default” called party station without having to actually dial the required called number. Such short cut or speed dialing of a default number proves convenient when a caller repetitively calls the same number from the same originating station over a period of time.

In the typical case of first use of a pre-paid card, the user will not have established account information corresponding to the card and, it will initially be assumed, no prior use of any pre-paid card has been made at the station corresponding to the received ANI. Accordingly, the platform 160 routinely provides a prompt for account information and conditions itself to receive input from the caller as shown at block 410 in FIG. 4. It proves convenient in illustrative embodiments to allow a caller to employ inputs from a tone dialing keypad to enter both digits and the ubiquitous * and # keys. In particular, the * key is illustratively associated with the notion of a “new” account or a “new” default called number. Similarly, the # key is conveniently used for indicating that the current or last used account associated with the received ANI should be that used for the current call. Also, the # key is conveniently used in some embodiments of the present invention by the caller to indicate that the current default called number should be used as the called number for the present call.

Thus, upon first use of a card, the user may choose to enter a * in response to the prompt presented by the platform at step 410 in FIG. 4 to indicate that a new account is to be used. User-keyed digits corresponding to the account (including the PIN) then follow the * signal to the platform. Alternatively, the caller may just enter the account information. Since the present use is assumed to be the first use of the card, entry of a # is ignored because there is no prior account associated with the received ANI. Thus a complete sequence of account information entered by the caller sets up a new account for that ANI; no * key is strictly necessary. The database is updated, i.e., the ANI and now-associated account data are entered into the database 340 in FIG. 3.

If the ANI received at block 401 in the process of FIG. 4 already has one or more accounts associated with it in the database 345 of FIG. 1, and the * key signal is received at platform 160, then the immediately following account data received at the platform is used to establish a new account. This is shown by the YES output from decision block 420 leading to block 425 in FIG. 4.

Continuing the discussion of processing in accordance with the steps shown in the flowchart of FIG. 4 (again assuming the first use of the card), it will be appreciated that no called number is known at the platform for the present pre-paid card. Accordingly, the platform (again using one of the VRUs 350-i) delivers a voice prompt to the user at the station identified by the current ANI information. The prompt will typically include a request for a called number, but may also include appropriate directions, including, i.e., use of the * key. One use of the * key in such circumstances is for having a called number entered by the user following the * key made a default called number for future platform access from the present ANI-identified station. Thus if a present called number entered by a user is preceded by a * key entry by that user, then the platform updates the stored information associated with the present ANI to include the present called number as the default called number. Upon future platform access from the station identified by the present ANI, the stored default number will be used if the user enters no new called number. In one embodiment of the present invention, a period of time is allowed to elapse (typically a few seconds) during which the entry of digits of a called number will cause the stored default number to not be used as the called number for the present call. Advantageously, even a single digit will cause the default number to not be selected.

As a convenient further shortcut, the # key may be employed to indicate to the platform 160 that the stored default number is to be used-without any required waiting period. This is shown in FIG. 4, where a YES decision upon testing for the # key following a prompt for a called number causes the default number to be used as the called number. If there is no default number stored, as will be the case on a first use of a card (or subsequent use without a called number having been designated as the default), receipt of a # key signal is ignored; the platform will continue to await keyed digits identifying a called number.

Block 450 indicates treatment of a received * key, as discussed above. In particular, the receipt of a * key before any called number digits is typically used to cause the received called number to replace the previous default called number, if any. Block 455 represents the setting of the following received called number as the future default. Advantageously, the resetting of the default called number is not accomplished until the receipt of the entire called number. This latter condition is tested in decision block 460. When all of the digits are received, the call is completed in accordance with standard processing, i.e., in accordance with normal pre-paid card processing. It will be noted that if no * key or # key is entered before current entry (prior to the passage of a “select default” time period, if any) of a desired called number, the current entry will be used.

Many variations of the above-described call flows are possible using the inventive principles of the invention. For example, in appropriate cases a simplified or constrained call completion process may prove useful, e.g., when one or more users will place calls from a given originating station for a period of time that are to be charged to a particular account. One application deals with an originating location assigned to persons at a meeting or party away from a home base. In such applications, it may be desired that only account information stored at a special service platform such as 160 in FIG. 1 be used for supplying account and PIN information, i.e., no originating station overrides may be permitted. In the context of the flow diagram of FIG. 4, this would illustratively involve skipping blocks 410, 415, 420 and 425 once appropriate account information has been lodged in the database (as by an original call enjoying special treatment or through database administration using illustrative console 360).

In other cases a more verbose call flow will be used. In one illustrative case, an original call to the special services platform 160 will be followed by a request for account number/PIN. After receipt of account/PIN information, the platform will request user approval (or not) for use of the indicated account/PIN only for calls from the present ANI-identified calling station. After prompting for and receiving called party identification, the platform may seek user approval (or not) for the restriction that the current account be used only for calls to the identified called party. Thus, the current account and current called identification would be used until the account balance (for pre-paid calling cards) is exhausted some other criterion is reached. Administration is always available by providing authorized account/called party information to be entered through illustrative service administration console 360 in FIG. 3.

Table 1 summarizes particular user inputs and results for one particular illustrative embodiment. There, the term “override” refers to use of a *, # or other key (or key sequence) to indicate a user choice rather than existing or default information.

TABLE 1

| ANI IN | DEFAULT | FIRST | SECOND | |
|---|---|---|---|---|
| DATA- | IN | OVER- | OVER- | |
| BASE | DATABASE | RIDE | RIDE | CALL RESULT |
| NO | NO | N/A | NONE OR | NEW ACCOUNT; |
| | | | # | CALLED NUMBER |
| | | | | NOT DEFAULT FOR |
| | | | | NEW ACCOUNT |
| NO | NO | N/A | * | NEW ACCOUNT; |
| | | | | CALLED NUMBER IS |
| | | | | DEFAULT FOR NEW |
| | | | | ACCOUNT |
| YES | NO | NONE | NONE OR | PRESENT ACCOUNT; |
| | | OR # | # | NEW CALLED |
| | | | | NUMBER; CALLED |
| | | | | NUMBER NOT NEW |
| | | | | DEFAULT |
| YES | NO | * | * | NEW ACCOUNT; NEW |
| | | | | CALLED NUMBER |
| | | | | (WHICH BECOMES |
| | | | | NEW DEFAULT) |
| YES | YES | NONE | NONE OR | PRESENT ACCOUNT; |
| | | OR # | # | DEFAULT I IS |
| | | | | CALLED NUMBER |
| YES | YES | NONE | * | PRESENT ACCOUNT; |
| | | OR # | | NEW CALLED |
| | | | | NUMBER |
| | | | | (WHICH BECOMES |
| | | | | NEW DEFAULT) |
| YES | YES | * | NONE OR | NEW ACCOUNT; NEW |
| | | | # | CALLED NUMBER |
| | | | | (WHICH IS NOT NEW |
| | | | | ACCOUNT DEFAULT) |
| YES | YES | * | * | NEW ACCOUNT; NEW |
| | | | | CALLED NUMBER |
| | | | | (WHICH IS NEW |
| | | | | ACCOUNT DEFAULT) |

Other special service call processing methods and systems for practicing such methods, all within the scope of the present invention, will occur to those skilled in the art. Thus, while particular user inputs (e.g., a * key input) are used to indicate a new account is to be used, or a new default called number is to be used, and others (e.g., a # key input) may be used to signify that prior account or default called numbers are to be used, no such particular inputs are central to the present invention.

While use of some illustrative embodiments of the present invention contemplate network signaling and control using SS7 protocols and messages, it will be clear to those skilled in the art that, in appropriate cases, other particular signaling and control means may be used. Thus, for example, multifrequency (MF) signaling techniques may be used for performing some or all of the signaling and control functions for interaction with platform 160 in the manner described above. Likewise, though the IAM message is advantageously employed in providing ANI and related information for use at network switches and platform 160, other particular signaling and control messages may be employed for supplying ANI or other originating station identification information.

While the illustrative embodiments disclosed above are presented in the context of special service telephone calls using a pre-paid card, the present inventive teachings are not so limited. Thus, for example, other pre-paid calling arrangements may be used; use by authorized users of a pre-paid combined total of (bulk) resources pre-paid by a corporation or other group may employ some or all of the present inventive features. That is, individual users may place calls from separate originating stations; only the first use at a particular station requires full account information, and default called numbers can be associated with each originating station.

In addition, other account-related access and network use, e.g., access to Internet (or other data network) voice call gateways for authentication, billing (including debit-based billing of subscriber balances) may be implemented using some or all of the features of embodiments of the present invention.

While originating station information in the form of ANI information has been used to illustrate certain aspects of the illustrative embodiments, no such use is essential to all uses of the present invention. Other station or person (including group or corporate) identification may be extracted and used in combination with information stored in a platform database or otherwise made available at a special services platform. Thus, for example, computers or computer processors may have pre-assigned (fixed or changeable) serial numbers or other identification indicia that may be automatically read at the source and presented over a communications link to special services platforms that can, in appropriate cases, be used in place of ANI information to extend or modify calling privileges or practices. In the case of an identification indicia associated with a mobile computer (laptop, handheld or otherwise), or a processor used in a mobile computer, processing at the special services platform can be performed in the manner described above, with a user only required to enter only the original dial-up (or other) connection to the special services platform.

Such non-ANI identification for mobile terminals that remain in continuing possession of an authorized user may be used to substitute for ANI in processing special service calls such as pre-paid card calls. It will be recognized, of course, that any attempted pre-paid call will be subject to the existence of a required remaining balance in the pre-paid account. It will also be recognized that suitable time measuring means, e.g., counters, will be used in appropriate cases to monitor the passage of time from the issuance of a prompt message to a user, or to monitor inter-digit pauses, all to the effect that, upon reaching predetermined values for accumulated time, a prompt will be repeated or a call sent to final disposition without completion, (e.g., a message directing the user to hang up and try again).

The above-described processing of account or related identification in combination with authentication and/or resource availability information at a platform will be seen to simplify and promote use by a subscriber or user in a variety of circumstances:

What is claimed is:

1. A method for processing special service telephone calls in a network interconnecting a plurality of stations, the method comprising the steps of
receiving information identifying the originating station for a current telephone call,
based on said identification of an originating station, identifying available special service call account information associated with said originating station in a database in said network,
completing a telephone call through said network based on identified account information in said database.

2. The method of claim 1 wherein account information associated with an originating station is not available in said database at the time of receipt of said information identifying said originating station, the method further comprising
generating at least one message directed to said originating station, said at least one message including a request for account information,
completing a call to an identified called station based on information received in response to said at least one message, and
updating said database to include received account information in association with said originating station identification.

3. The method of claim 2 wherein said updating of said database further comprises associating in said database a default called number associated with said originating station.

4. The method of claim 3 wherein said association in said database of a default number with said originating station is performed in response to a code preceding a called number received at a processor for controlling said database.

5. The method of claim 1 wherein said account information associated with at least some of said originating stations in said database comprises default called station information, said method further comprising
completing said current telephone call to a default called station if said account information associated with said originating station identifies a default called number.

6. The method of claim 5 wherein said completing of said current telephone call to a default called station is accomplished in response to a code received subsequent to receipt of said originating station information.

7. The method of claim 1 wherein said originating station identification information comprises ANI information.

8. The method of claim 2 wherein said at least one message comprises at least one voice prompt.

9. The method of claim 8 wherein said at least one voice prompt comprises a first voice prompt requesting account information and a second prompt requesting called number information.

10. The method of claim 1 further comprising
receiving a first code requesting that current account information associated with received originating station information not be used for the present call,
receiving new account information to be used for completing the present call, and
completing the present call based on said new account information.

11. The method of claim 10 wherein new account information is received in response to at least a first voice prompt.

12. The method of claim 11 wherein said call is completed to a number received in response to a second voice prompt.

13. The method of claim 10 further comprising
updating said database in response to said received first code, said updating comprising associating said new account information with said originating station information for the present call.

14. The method of claim 10 wherein said present call is a pre-paid card call and said completing of said present call is conditional upon said account information further comprising a sufficient remaining balance of pre-paid resources.

15. The method of claim 1 further comprising
receiving a first code requesting that current account information associated with received originating station information be used for the present call, and
completing the present call based on available account information.

16. The method of claim 15 further comprising
sending a prompt to said originating station for a called number, and
completing said present call based on a received called number.

17. The method of claim 15 further comprising
sending a prompt to said originating station for a called number, and
completing said present call to a default number stored in said database in response to the passage of a predetermined period of time after said prompt during which no called number is received.

18. The method of claim 15 further comprising
sending a prompt to said originating station for a called number, and
completing said present call to a default number stored in said database based on receipt of a second code received in response to said prompt for a called number.

19. The method of claim 2 wherein said at least one message comprises a request for user input as to restrictions to be placed on the use of account information.

20. The method of claim 19 wherein said restrictions include the use of said account information only for calls originating at said originating station.

21. The method of claim 19 wherein said restrictions include the use of said account information only for calls to said identified called station.
